(19) United States
(12) Patent Application Publication
(10) Pub. No.: US 2026/0103993 A1
(43) Pub. Date: Apr. 16, 2026

(54) ABRADABLE COATING

(71) Applicant: RTX Corporation, Farmington, CT (US)

(72) Inventors: Alex SCHNEIDER, Manchester, CT (US); Peter WILKINS, Manchester, CT (US); Winston SMIDDY, South Windsor, CT (US); Paul Lutjen, Kennebunkport, ME (US)

(73) Assignee: RTX Corporation, Farmington, CT (US)

(21) Appl. No.: 18/917,918

(22) Filed: Oct. 16, 2024

(51) Int. Cl. F01D 11/12

(52) U.S. Cl. CPC F01D 11/122; F05D 2230/311; F05D 2230/312; F05D 2230/90; F05D 2300/175; F05D 2300/21; F05D 2300/514; F05D 2300/6033; F05D 2300/611

(57) ABSTRACT

An abradable coating/thermal barrier coating suitable for use with jet engine CMC components is described which comprises a material selected from hafnon, mixtures of hafnon and zircon, and rare earth disilicates (RE₂Si₂O₇), wherein RE is Sc, Y, La, Ce, Pr, Nd, Pm, Sm, Eu, Gd, Tb, Dy, Ho, Er, Tm, Yb, or Lu. The coating has a porosity gradient wherein the porosity decreases in a radial direction. The porosity gradient provides a progressively increasing wear resistance to slow the rate of rub interaction. The porosity gradient also reduces the thermal gradient through the coating thereby reducing the formation of thermal stresses within the coating and any underlying CMC component.

### FIELD OF THE INVENTION

The present disclosure relates generally to abradable coatings and thermal barrier coatings (TBCs) and methods of preparation of abradable coatings. In particular, the present disclosure concerns abradable/thermal barrier coatings for use with components made form ceramic matrix materials (CMCs) or superalloys.

### BACKGROUND OF THE INVENTION

Gas turbine engines, in general, include a fan section, a compressor section, a combustion chamber, and a turbine section. Air enters through the fan section and is compressed in the compressor section before being introduced into the combustion section. In the combustion section, the air is mixed with fuel and ignited to generate a high-energy, high temperature gas flow. The high-energy, high temperature gas flow is expanded in the turbine section which is used to create thrust and to drive the compressor and fan sections.

Thus, turbomachinery, such as gas turbine engines, have components that are exposed to hostile environments due to high temperatures. Therefore, it is desirable that such components be made of heat resistant materials such as superalloys or ceramic matrix composites (CMCs). While CMC materials can withstand much higher operating temperatures than superalloys, components made from both of these materials can be provided with coatings to enhance their ability to withstand high temperatures and/or to protect the underlying substrates from the corrosive nature of the high-energy, high temperature gas flow.

The engine components exposed to high temperatures include such as turbine blades, turbine airfoils, seals, and combustor liners. For example, the turbine section includes low and high pressure turbines having a plurality of turbine blades. The turbine section further includes a blade outer air seal (BOAS), which may be a full continuous annulus or may be segmented, to prevent/minimize leakage of the high-energy, high temperature gas flow, i.e., the working fluid, around the blade tips as it flows through the turbine section. Avoiding/minimizing such leakage increases the overall operating efficiency of the gas turbine engine.

Some components used in gas turbine engines, such as turbine blades, are positioned within close proximity to a stationary surface which is, or acts as, a seal to avoid leakage, such as the BOAS as described above. During operation, as a result of this close proximity, blade tips and seals may come into contact. Damage to the blades, particularly the blade tips, can lead to serious damage to the engine detrimentally impacting the operational lifespan of the engine and the safety of operation. To avoid or alleviate such problems, steps are taken so that when rub interaction occurs between the blade and the seal, the damage is absorbed by the coating, and not the blade.

For example, to avoid damage to the blades, surfaces that are in close proximity to rotating blades, such as seals, are often provided with abradable coatings. These abradable coatings are designed so that the blade tips act as an abrading component with respect to the abradable coating. That is, the blade tip materials are harder than those used for the abradable coating. With the blade tip materials being harder, the blade tips will abrade or cut into the abradable coating when a blade tip contacts the abradable seal during the engine operating cycle.

To provide the desired abradability, coatings can be provided that have a low density due to higher porosity, for example, >20% porosity. Such high porosity/low density materials exhibit lower mechanical strength then the blade tips. Therefore, when rub interaction with the blade tip occurs, the high porosity/low density abradable coating will abrade avoiding damage to the blade tip.

However, the resultant permeability of high porosity of the abradable coating can lead to higher thermal gradients though the coating, leading to higher surface temperatures at the surface of the component to which it is applied, e.g., a BOAS. It is desirable to provide such components with not only an abradable coating but also to provide protection from the high temperatures caused by the high-energy, high temperature gas flow, thereby increasing the operational lifespan of such components.

A further type of coating used jet engine components are thermal barrier coatings (TBCs). TBCs are applied to components having CMC or superalloy substrates that are exposed to high temperatures. TBCs are ceramic coatings that exhibit very low thermal conductivity and thus protect the underlying substrate to which they are applied from excessive temperatures. For example, TBCs can be applied to the surface of turbine blades to provide thermal insulation to allow for blade surface temperatures to exceed that which would be detrimental to the underlying blade substrate. Porosity is also a factor in TBCs as high porosity can increase thermal conductivity thereby reducing the ability of the TBC to limit thermal conduction.

There exists a continuing to need for methods and materials for producing abradable/thermal barrier coatings that enhance the properties of the resultant coatings and/or facilitate the manufacture thereof.

### SUMMARY OF THE INVENTION

In general, the present disclosure relates to an abradable coating having exhibiting a radial porosity gradient such that the surface of the coating in close proximity to an abrading element has a higher porosity than the surface of the coating in close proximity to the surface of the underlying component.

The present disclosure is directed, in a first aspect, to a coated substrate having:
a substrate made from a superalloy or a ceramic matrix composite (CMC) material having a radially outward surface and a radially inward surface;
a coating system applied to the radially inward surface of the substrate, the coating system includes a coating having an abradable coating region or thermal barrier coating region made of material selected from hafnon, mixtures of hafnon and zircon, and rare earth disilicates (RE₂Si₂O₇), wherein RE is Sc, Y, La, Ce, Pr, Nd, Pm, Sm, Eu, Gd, Tb, Dy, Ho, Er, Tm, Yb, or Lu;
wherein the coating has a first surface proximate with respect to the radially inward surface and a second surface distal with respect to the radially inward surface, and the abradable coating region or thermal barrier coating region has a porosity wherein the porosity decreases from the first surface to the second surface in a linear or stepwise manner such that a first region of the abradable coating region encompassing the first surface has a porosity of at least 60% of the total volume of the first region and a second region of the coating encompassing the second surface has a porosity of not more than 10% of the total volume of the second region.

In yet another embodiment, the present disclosure is directed to a method of preparing a jet engine component comprising:
providing a superalloy or CMC substrate; and
applying a coating system to a surface of the superalloy or CMC substrate, the coating system including a coating having an abradable coating region or thermal barrier coating region made of material selected from hafnon, mixtures of hafnon and zircon, and rare earth disilicates (RE₂Si₂O₇), wherein RE is Sc, Y, La, Ce, Pr, Nd, Pm, Sm, Eu, Gd, Tb, Dy, Ho, Er, Tm, Yb, or Lu;
wherein the coating has a first surface proximate with respect to the radially inward surface and a second surface distal with respect to the radially inward surface, and the abradable coating region or thermal barrier coating region has a porosity wherein the porosity decreases from the first surface to the second surface in a linear or stepwise manner such that a first region of the abradable coating region encompassing the first surface has a porosity of at least 60% of the total volume of the first region and a second region of the coating encompassing the second surface has a porosity of not more than 10% of the total volume of the second region.

In yet another embodiment, the present disclosure is directed to a gas turbine engine having:
a fan section, a compressor section, a combustion section, and a turbine section, the turbine section including at least one rotor and one or more turbine blade(s) extending radially outwardly from the at least one rotor;
a blade outer air seal assembly positioned between the one or more turbine blade(s) and an outer casing to the engine;
the blade outer air seal is formed of a plurality blade outer air seal segments, wherein each blade outer air seal segment comprises
   a substrate made from a superalloy material or ceramic matrix composite (CMC) material having a radially outward surface and a radially inward surface;
   a coating system applied to the radially inward surface of the substrate, the coating system includes a coating having an abradable coating region or thermal barrier coating region made of material selected from hafnon, mixtures of hafnon and zircon, and rare earth disilicates (RE2Si2O7), wherein RE is Sc, Y, La, Ce, Pr, Nd, Pm, Sm, Eu, Gd, Tb, Dy, Ho, Er, Tm, Yb, or Lu;
   wherein the coating has a first surface proximate with respect to the radially inward surface and a second surface distal with respect to the radially inward surface, and the abradable coating region or thermal barrier coating region has a porosity wherein the porosity decreases from the first surface to the second surface in a linear or stepwise manner such that a first region of the abradable coating region encompassing the first surface has a porosity of at least 60% of the total volume of the first region and a second region of the coating encompassing the second surface has a porosity of not more than 10% of the total volume of the second region.

In further embodiments of the present disclosure, including further embodiments of the above exemplary embodiments, the substrate is made from a superalloy.

In further embodiments of the present disclosure, including further embodiments of the above exemplary embodiments, the substrate is made from a ceramic matrix composite (CMC) material.

In further embodiments of the present disclosure, including further embodiments of the above exemplary embodiments, the porosity decreases from the first surface to the second surface in a linear manner.

In further embodiments of the present disclosure, including further embodiments of the above exemplary embodiments, the porosity decreases from the first surface to the second surface in a linear manner.

In further embodiments of the present disclosure, including further embodiments of the above exemplary embodiments, the porosity decreases from the first surface to the second surface in a stepwise manner.

In further embodiments of the present disclosure, including further embodiments of the above exemplary embodiments, the abradable coating region or thermal barrier coating region contains three or more layers with each layer having a different porosity.

In further embodiments of the present disclosure, including further embodiments of the above exemplary embodiments, the porosity decreases from the first surface to the second surface in a linear or stepwise manner such a first region of the coating encompassing the first surface has a porosity of at least 60% of the total volume of the first region and a second region of the coating encompassing the second surface has a porosity of not more than 5% of the total volume of the second region.

In further embodiments of the present disclosure, including further embodiments of the above exemplary embodiments, the material of the abradable coating region or thermal barrier coating region is hafnon or a mixture of hafnon and zircon.

In further embodiments of the present disclosure, including further embodiments of the above exemplary embodiments, the material of the abradable coating region or thermal barrier coating region is a mixture of hafnon and zircon wherein the molar ratio of hafnon to zircon is 2:1 to 4:1.

In further embodiments of the present disclosure, including further embodiments of the above exemplary embodiments, the material of the abradable coating region or thermal barrier coating region is selected from rare earth disilicates (RE2Si2O7), wherein RE is Sc, Y, La, Ce, Pr, Nd, Pm, Sm, Eu, Gd, Tb, Dy, Ho, Er, Tm, Yb, or Lu.

In further embodiments of the present disclosure, including further embodiments of the above exemplary embodiments, the abradable coating region or thermal barrier coating region has a thickness of 50 μm to 1500 μm.

In further embodiments of the present disclosure, including further embodiments of the above exemplary embodiments, the abradable coating region or thermal barrier coating region has a thickness of 50 to 750 μm.

In further embodiments of the present disclosure, including further embodiments of the above exemplary embodiments, the coated substrate is a blade outer seal or blade outer seal segment.

In further embodiments of the present disclosure, including further embodiments of the above exemplary embodiments, the coating system is applied by thermal spraying.

In further embodiments of the present disclosure, including further embodiments of the above exemplary embodiments, the coating system is applied by air plasma spraying (APS).

In further embodiments of the present disclosure, including further embodiments of the above exemplary embodiments, the coating has an abradable coating region and further includes EBC regions or TBC regions on either side of the abradable coating region.

### BRIEF DESCRIPTION OF FIGURES

The features of the disclosure believed to be novel and the elements characteristic of the invention are set forth with particularity in the appended claims. Implementations of the inventive concepts disclosed herein may be better understood when consideration is given to the following description of the figures. The figures are for illustration purposes only and are not drawn to scale. These drawings are not necessarily to scale, and which some features may be exaggerated and some features may be omitted or may be represented schematically in the interest of clarity. Like reference numerals in the drawings may represent and refer to the same or similar element, feature, or function. The disclosure itself, however, both as to organization and method of operation, can best be understood by reference to the description of the preferred embodiment(s) which follows, taken in conjunction with the accompanying drawings in which:

FIG. 1 schematically illustrates an example gas turbine jet engine.

FIG. 2 a seal structure for a gas turbine engine having an abradable coating.

FIG. 3 illustrates a cross section of the seal structure of FIG. 2 along line B-B showing an abradable coating according to the present disclosure.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art. It is to be understood that all concentrations disclosed herein are by weight percent (wt. %.) based on a total weight of the composition unless otherwise indicated.

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of the embodiments of the inventive concepts, numerous specific details are set forth in order to provide a more thorough understanding of the inventive concepts. It will be apparent to one skilled in the art, however, having the benefit of the instant disclosure that the inventive concepts disclosed herein may be practiced without these specific details.

In the discussion below, axial refers to a direction that coincides with the longitudinal axis of the engine. Radial refers to a direction that is radial with respect to the longitudinal axis of the engine. Circumferential refers to a direction that corresponds to the circumference of a circle around the longitudinal axis of the engine. The leading edge/portion of a structure is the edge/portion that faces into the flow of the hot gases, i.e., faces upstream. The trailing edge/portion of a structure is the edge/portion that faces away from the flow of the hot gases, i.e., faces downstream.

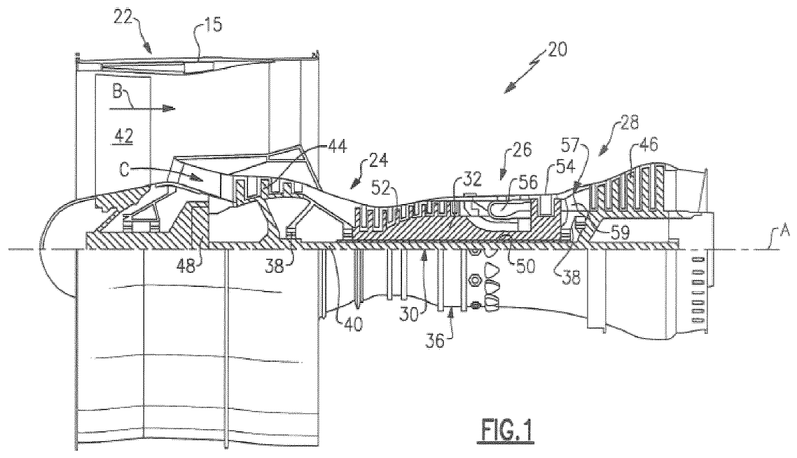

FIG. 1 schematically illustrates an example of a gas turbine jet engine 20 (i.e., a two-spool turbofan) which includes a fan section 22, a compressor section 24, a combustor section 26, and a turbine section 28. Fan section 22 drives air along a bypass flow path B in a bypass duct defined within a housing 15, and also along a core flow path C for compression in compressor section 24, with subsequent introduction into combustor section 26, followed by expansion through turbine section 28. Although FIG. 1 depicts a two-spool turbofan gas turbine jet engine, it should be understood that the concepts described herein are not limited to use with two-spool turbofans engines and may be applied to other types of turbine jet engines.

Engine 20 generally includes a low speed spool 30 and a high speed spool 32 mounted for rotation about an engine central longitudinal axis A, relative to an engine static structure 36, via several bearing systems 38. Various bearing systems 38 at various locations may alternatively or additionally be provided. The location of bearing systems 38 may be varied as appropriate to the application.

The low speed spool 30 generally includes an inner shaft 40 that interconnects, a first (or low) pressure compressor 44 and a first (or low) pressure turbine 46. Inner shaft 40 is connected to fan 42 through a speed change mechanism, which in this exemplary embodiment is illustrated as a geared structure 48 to drive fan 42 at a lower speed than the low speed spool 30. High speed spool 32 includes an outer shaft 50 that interconnects a second (or high) pressure compressor 52 and a second (or high) pressure turbine 54. Combustor 56 is positioned between high pressure compressor 52 and high-pressure turbine 54. A mid-turbine frame 57 of the engine static structure 36 may be arranged generally between the high-pressure turbine 54 and the low-pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core air flow is first compressed by low pressure compressor 44, and then by the high-pressure compressor 52. Thereafter, the core air flow is mixed and burned with fuel in combustor 56, then expanded in high pressure turbine 54 and low-pressure turbine 46. The mid-turbine frame 57 includes airfoils 59 which are in the core airflow path C. The turbines 46 and 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low-pressure compressor, or aft of the combustor section 26 or even aft of turbine section 28, and fan 42 may be positioned forward or aft of the location of gear system 48.

The turbine section 28 includes a blade outer air seal(s) (BOAS(s)). Generally, the blade outer air seal is made up of a plurality of BOAS segments that form an annular shaped shroud around the engine central longitudinal axis A.

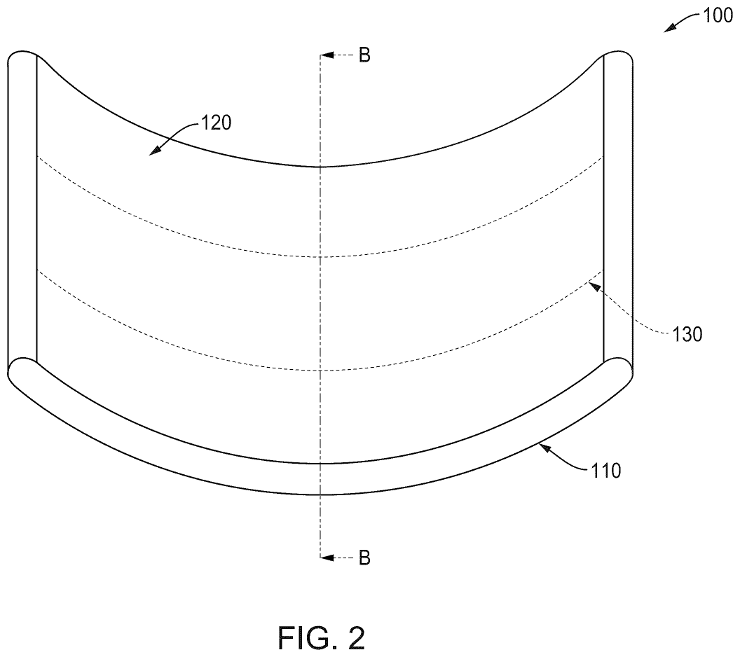

FIG. 2 illustrates an example of a portion of a seal 100 (e.g., a BOAS segment) for a gas turbine engine which includes a base having convex radially outward surface 110 and a concave radially inward surface 120. The inward surface 120 faces the interior of the engine and is exposed to the high-energy, high temperature gas flow. The outward surface 110, on the other hand, can be subjected to a coolant flow, e.g., cooling air flow, to protect the seal from excessive temperatures. This can cause the formation of a thermal gradient between outward surface 110 and inward surface 120, which in turn can lead to creation of thermal stress.

On the inward surface 120, a region 130 is shown. This represents the region where rub interaction events between the blade and the seal will occur. In accordance with the present disclosure, the inward surface 120 has a coating layer, particularly in the rub interaction region 130, that is abradable so that when contact occurs between the seal 100 and, for example, a blade, the blade tip will abrade the abradable coating. In other words, the blade tip has the higher hardness and acts as an abrading component with respect to the abradable coating. In this regard, it is noted that that the blade tip may itself be provided with a coating to increase its hardness or abrasiveness (e.g., tipping abrasives). Thus, the abradability of the coating is selected so that its hardness is lower than that of the blade tip (whether coated or uncoated) to achieve the desired rub interaction between these two structural elements.

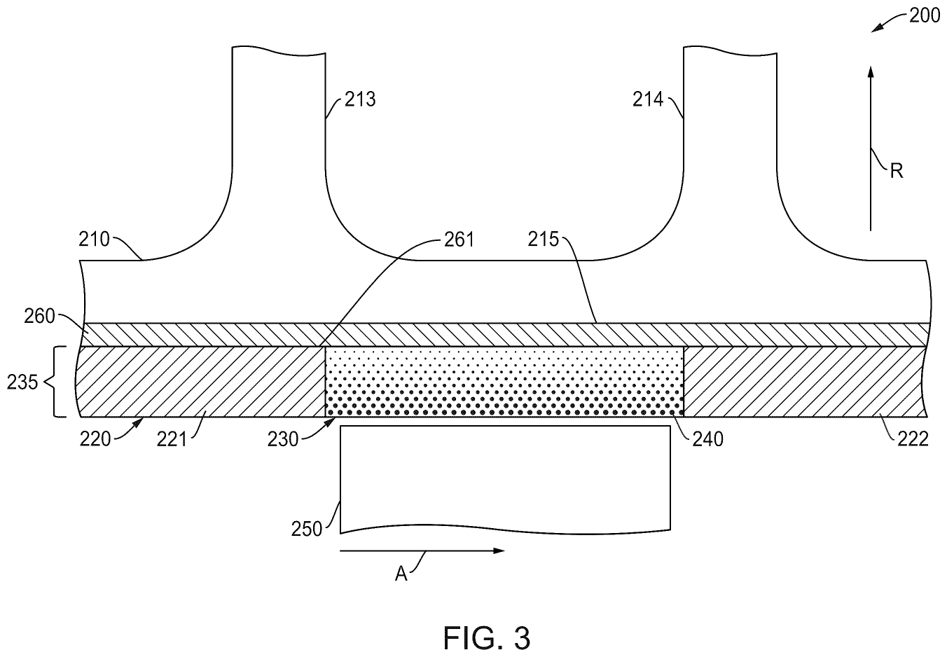

FIG. 3 shows a cross section of the seal of FIG. 2 along line B-B. In this embodiment, the seal 200, e.g., a BOAS, is shown with two vertical flanges 213 and 214 (not shown in FIG. 2) extending from the radially outward surface 210. These flanges provide means for attaching the seal to an outer casing of the jet engine. Proceeding in an axial direction A, the radially inward surface 220 includes a first region 221, the rub interaction region 230, and a second region 222. As shown, the rub interaction region 230 is in close proximity to the blade tip of turbine blade 250. The seal 200 is made from a ceramic matrix composite (CMC) material having a surface 215 to which a coating system is applied. The CMC material can comprise ceramic fiber tows (e.g., SiC fiber tows) within a ceramic matrix (e.g., an SiC matrix). The CMC can also be formed from other fiber/matrix combinations such as C/C, C/Si, and alumina/alumina.

The coating system includes a layer 235 having an abradable coating section 240 at the rub interaction region 230 and barrier coating at regions 221 and 222. These barrier coatings can be TBCs or environmental barrier coatings (EBCs). EBCs applied to the surface of CMC substrates to protect the substrate from corrosive forces due to, for example, exposure to high temperature water vapor.

As shown in FIG. 3, the rub interaction region 230 can be slightly wider than the width directly impacted by the blade tip in order to allow for some axial movement of the blade 250. Between layer 235 and surface 215 is are one or more optional layers 260. For example, the layers 260 can be a first bond coat layer (e.g., a Si-containing layer), to promote adherence between the ceramic matrix composite surface 215 and a subsequent layer, and top coat layer having environmental barrier properties. As shown, when layer(s) 260 are present, the layer 235 is applied to a surface 261 of the adjacent layer 260.

As shown in FIG. 3, the abradable coating has a varying porosity. In the embodiment of FIG. 3, the pores of the abradable coating decrease in size in going from the radially inward surface 220 to surface 215 of ceramic matrix composite material (or surface 261 of the bond coat). This decrease in pore size represents a decreasing porosity gradient in the radial direction R, which is either linear or stepwise, whereby the porosity of a first region of the coating, encompassing the surface 220, has a porosity of at least 60% of the total volume of the first region and the porosity of a second region of the abradable coating, adjacent the surface 215/261, has a porosity of not more than 10% of the total volume of the second region. As mentioned, a gradient is formed whereby the porosity from the first region decreases linearly or stepwise to the porosity of the second region.

The porosity gradient achieves at least two effects. It provides for a progressively increasing wear resistance thereby slowing the rate of rub interaction. Additionally, there will be an advantageous impact on the thermal gradient within the coating. As the porosity of the coating decreases heat transfer through the coating will reduce. Thus, the thermal gradient within the coating will decrease, thereby reducing the formation of thermal stresses within the coating and the underlying CMC component.

Thus, the coating with its porosity gradient can also act as a thermal barrier coating on a superalloy substrate or CMC substrate. Suitable superalloys include Iron-based, nickel-based, and cobalt-based superalloys. In the case a superalloy substrate an optional bond coat can be also used between the substrate and the coating. The bond coat layer for a superalloy substrate can be, for example, diffusion aluminide or NiCoCrAlYHfSi based coatings. When using superalloy substrates, EBC coating regions are generally not used.

Regarding the porosity gradient, the porosity of the first region is at least 40 vol %, for example, at least 45%, at least 50%, at least 55%, at least 60%, at least 65 vol %, at least 70 vol %, or at least 75 vol %. The porosity of the second region is not more than 10 vol %, for example, not more than 7 vol %, not more than 5 vol %, or not more than 3 vol %. While the change in porosity is described above in terms of decreasing pore size, a decrease in porosity can also be obtained by decreasing the number of pores. In other words, the pores throughout the abradable coating can all be within a certain size range but the pore concentration decreases in going from the radially inward surface 220 to surface 215 of ceramic matrix composite material or surface 261 of the bond coat. In the case where the porosity gradient decreases in a stepwise manner, the abradable coating can have at least three layers of different porosities. For example, the abradable coating can have 3 to 10 layers, 3 to 7 layers, or 3 to 5 layers, wherein the porosity decreases from layer to layer starting from the layer at the radially inward surface of the coated component. Thus, in one exemplary embodiment, the abradable coating has three layers wherein the first layer (closest to the CMC/superalloy substrate) has a porosity of at most 10 vol %, the second layer has a porosity of 20-50 vol %, and the third layer (closest to the hot gas path and the abrading component) has a porosity of at least 60 vol %. In another exemplary, the abradable coating has four layers wherein the first layer (closest to the CMC substrate) has a porosity of at most 10 vol %, the second layer has a porosity of 20-30 vol %, the third layer has a porosity of 40-50 vol %, and the fourth layer (closest to the hot gas path and the abrading component) has a porosity of at least 60 vol %.

In accordance with an embodiment of the present disclosure, the abradable coating or thermal barrier coating comprises a material selected from hafnon, mixtures of hafnon and zircon, and rare earth disilicates (RE₂Si₂O₇), wherein RE is Sc, Y, La, Ce, Pr, Nd, Pm, Sm, Eu, Gd, Tb, Dy, Ho, Er, Tm, Yb, or Lu. Regarding mixtures of hafnon and zircon, these include, for example, mixtures wherein the molar ratio of hafnon to zircon is 2:1 to 4:1, such as 7:3 to 3:1. The abradable coating or thermal barrier coating can be applied in a variety of thicknesses. For example, the abradable coating can have a thickness of 50 μm to 1500 μm, such as 50 μm to 1000 μm, 50 μm to 750 μm, 50 μm to 500 μm, and 50 to 750 μm. The thickness of the TBC coating can be up to about 2,000 μm, e.g. 25 to 2,000 μm, 50 to 2000 μm, 100 to 2000 μm, 100 to 1000 μm, 100 to 400 μm, or 200 to 300 μm.

The abradable coating/thermal barrier coating (or layers thereof) can be applied by, for example, thermal spraying. For example, the abradable coating or thermal barrier coating can be applied by air plasma spraying (APS), low pressure thermal spray (LPPS), flame spraying (such as high velocity oxygen fuel spraying (HVOF) and high velocity air fuel spraying HVAF) and suspension plasma spraying.

Several different approaches can be used to induce changes in porosity. For example, the particle size of the powdered materials to be applied by thermal spraying can be changed to induce changes in the size of pores formed during application of the material. Thus, in thermal spraying a powdered material is heated to a semi-molten state and then deposited onto a substrate in the form of semi-molten particles referred to as splats. The process will result in pores being formed between the deposited splats. By decreasing the particle size of the powdered material, the resultant splat size will also decrease as will the size of the pores formed between the deposited splats. Therefore, by increasing the particle size of the powdered material in a continuous or stepwise manner, the porosity of the coating deposited onto the substrate will increase in a linear or stepwise manner as more material is deposited.

Another approach would be to incorporate a fugitive material into the coating. Once the coating is applied, the fugitive material can be removed by, for example, heating to form voids/pores in the coating. The fugitive material can be incorporated into the material to be deposited by thermal spraying. By changing the particle size of the fugitive material during the thermal spraying the size of the resultant voids/pores formed upon removal of the fugitive material can be changed thus changing porosity. Alternatively, rather than changing the particle size of the fugitive material, one can change the concentration of the fugitive material relative to the powdered material used for making the coating itself (i.e., change the rate of fugitive material laydown), thereby changing the resultant pore concentration. Here again, the changes to the fugitive material (particle size or concentration) can be performed in a continuous or stepwise manner to create a linear or stepwise porosity gradient within the coating.

As noted above, the abradable coating, for example, can be part of a layer that also includes regions of other coatings such as EBCs. To produce a coating having different material regions, templates can be used. For example, a first template can be positioned to cover the rub interaction region during the deposition of the EBC on the regions on either side of the rub interaction region. Thereafter, a second template can be positioned to cover the deposited EBC regions during deposition of the abradable coating to confine the abradable coating to the rub interaction region. These steps can also be reversed, i.e., the abradable coating can be deposited first using described second template and then subsequently the EBC can be applied using the first template.

Another approach would be to deposit the layer that contains both the EBC regions and the abradable coating by a series of linear passings with differing chemistries during the thermal spraying. For example, an initial layer of the forward region of EBC can be applied to the substrate (CMC component) by a series of linear passes using APS. Then, the chemistry of the feed materials for the APS can be switched to those needed for the abradable coating and the initial (low porosity) abradable coating layer can be applied by a series of linear passes. Thereafter, the feed material chemistry can change again and the aft region of EBC can be applied to the substrate by a series of linear passes using APS. The process would continue in this same manner until the coating is completed, with the feed material chemistry for the abradable coating changing with each series of linear passes to affect a porosity change as described above.

The corresponding structures, material, acts, and equivalents of all means or steps plus function elements in the claims below are intended to include any structure, material, or act for performing the function in combination with other claimed elements are specifically claimed. The above description of the present invention has been presented for purposes of illustration and description, but is not intended to be exhaustive or limited to the invention in the form disclosed. Many modifications and variations will be apparent to those of ordinary skill without departing from the scope and spirit of the invention. The specific embodiment(s) described above were chosen and described in order to explain principles of the invention and the practical applications thereof, and to enable others of ordinary skill in the art to understand the invention for embodiments with various modifications as are suited to the particular use contemplated.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

1. A coated substrate comprising:
a substrate made from a superalloy or a ceramic matrix composite (CMC) material having a radially outward surface and a radially inward surface;
a coating system applied to the radially inward surface of the substrate, said coating system includes a coating having an abradable coating region or thermal barrier coating region made of material selected from hafnon, mixtures of hafnon and zircon, and rare earth disilicates (RE₂Si₂O₇), wherein RE is Sc, Y, La, Ce, Pr, Nd, Pm, Sm, Eu, Gd, Tb, Dy, Ho, Er, Tm, Yb, or Lu;
wherein the coating has a first surface proximate with respect to the radially inward surface and a second surface distal with respect to the radially inward surface, and the abradable coating region or thermal barrier coating region has a porosity wherein the porosity decreases from the first surface to the second surface in a linear or stepwise manner such that a first region of the abradable coating region encompassing the first surface has a porosity of at least 60% of the total volume of the first region and a second region of the coating encompassing the second surface has a porosity of not more than 10% of the total volume of the second region,
wherein the coating is directly applied to the radially inward surface or is directly applied to a bond coat which is directly applied to the radially inward surface.

2. The coated substrate according to claim 1, wherein the substrate is made from a superalloy.

3. The coated substrate according to claim 1, wherein the substrate is made from a ceramic matrix composite (CMC) material.

4. The coated substrate according to claim 1, wherein the porosity decreases from the first surface to the second surface in a linear manner.

5. The coated substrate according to claim 1, wherein the porosity decreases from the first surface to the second surface in a stepwise manner.

6. The coated substrate according to claim 5, wherein the abradable coating region or thermal barrier coating region contains three or more layers with each layer having a different porosity.

7. The coated substrate according to claim 1, wherein the porosity decreases from the first surface to the second surface in a linear or stepwise manner such that the first region of the coating encompassing the first surface has a porosity of at least 60% of the total volume of the first region and the second region of the coating encompassing the second surface has a porosity of not more than 5% of the total volume of the second region.

8. The coated substrate according to claim 1, wherein the material of the abradable coating region or thermal barrier coating region is hafnon or a mixture of hafnon and zircon.

9. The coated substrate according to claim 8, wherein the material of the abradable coating region or thermal barrier coating region is a mixture of hafnon and zircon wherein the molar ratio of hafnon to zircon is 2:1 to 4:1.

10. The coated substrate according to claim 1, wherein the material of the abradable coating region or thermal barrier coating region is selected from rare earth disilicates (RE₂Si₂O₇), wherein RE is Sc, Y, La, Ce, Pr, Nd, Pm, Sm, Eu, Gd, Tb, Dy, Ho, Er, Tm, Yb, or Lu.

11. The coated substrate according to claim 1, wherein the abradable coating region or thermal barrier coating region has a thickness of 50 μm to 1500 μm.

12. The coated substrate according to claim 1, wherein the abradable coating region or thermal barrier coating region has a thickness of 50 to 750 μm.

13. The coated substrate according to claim 1, wherein said coated substrate is a blade outer air seal or blade outer air seal segment.

14. A method of preparing a jet engine component comprising:
providing a superalloy or a ceramic matrix composite (CMC) substrate having a radially outward surface and a radially inward surface; and
applying a coating system to a surface of the superalloy or CMC substrate, said coating system including a coating having an abradable coating region or thermal barrier coating region made of material selected from hafnon, mixtures of hafnon and zircon, and rare earth disilicates (RE₂Si₂O₇), wherein RE is Sc, Y, La, Ce, Pr, Nd, Pm, Sm, Eu, Gd, Tb, Dy, Ho, Er, Tm, Yb, or Lu;
wherein the coating has a first surface proximate with respect to the radially inward surface and a second surface distal with respect to the radially inward surface, and the abradable coating region or thermal barrier coating region has a porosity wherein the porosity decreases from the first surface to the second surface in a linear or stepwise manner such that a first region of the abradable coating region encompassing the first surface has a porosity of at least 60% of the total volume of the first region and a second region of the coating encompassing the second surface has a porosity of not more than 10% of the total volume of the second region.

15. The method according to claim 14, wherein the coating system is applied by thermal spraying.

16. The method according to claim 14, wherein the coating system is applied by air plasma spraying (APS).

17. The method according to claim 14, wherein the coating has an abradable coating region and further includes environmental barrier coating (EBC) regions on either side of the abradable coating region.

18. The method according to claim 14, wherein in the abradable coating region the porosity decreases from the first surface to the second surface in a linear manner.

19. The method according to claim 14, wherein in the abradable coating region the porosity decreases from the first surface to the second surface in a stepwise manner.

20. A gas turbine engine comprising:
a fan section, a compressor section, a combustion section, and a turbine section, said turbine section including at least one rotor and one or more turbine blade(s) extending radially outwardly from said at least one rotor;
a blade outer air seal assembly positioned between the one or more turbine blade(s) and an outer casing to the engine;
said blade outer air seal is formed of a plurality blade outer air seal segments, wherein each blade outer air seal segment comprises:
a substrate made from a superalloy material or ceramic matrix composite (CMC) material having a radially outward surface and a radially inward surface;
a coating system applied to the radially inward surface of the substrate, said coating system includes a coating having an abradable coating region or thermal barrier coating region made of material selected from hafnon, mixtures of hafnon and zircon, and rare earth disilicates (RE₂Si₂O₇), wherein RE is Sc, Y, La, Ce, Pr, Nd, Pm, Sm, Eu, Gd, Tb, Dy, Ho, Er, Tm, Yb, or Lu;
wherein the coating has a first surface proximate with respect to the radially inward surface and a second surface distal with respect to the radially inward surface, and the abradable coating region or thermal barrier coating region has a porosity wherein the porosity decreases from the first surface to the second surface in a linear or stepwise manner such that a first region of the abradable coating region encompassing the first surface has a porosity of at least 60% of the total volume of the first region and a second region of the coating encompassing the second surface has a porosity of not more than 10% of the total volume of the second region.
